(19) United States
(12) Patent Application Publication
(10) Pub. No.: US 2025/0217980 A1
(43) Pub. Date: Jul. 3, 2025

(54) APPARATUS AND METHOD FOR PREDICTING DIFFUSING CAPACITY USING FLOW-VOLUME CURVE IMAGE BASED ON DEEP LEARNING

(71) Applicant: Seoul National University R&DB Foundation, Seoul (KR)

(72) Inventors: Changhyun Lee, Seoul (KR); Chang-Hoon Lee, Seoul (KR); Sunmi Choi, Seoul (KR); Wonchul Chung, Seoul (KR)

(21) Appl. No.: 19/063,166

(22) Filed: Feb. 25, 2025

(30) Foreign Application Priority Data
Dec. 28, 2023 (KR) 10-2023-0194902
Dec. 30, 2024 (KR) 10-2024-0201354

(51) Int. Cl. G06T 7/00

(52) U.S. Cl. CPC G06T 7/0012; G06T 2207/20081; G06T 2207/30061

(57) ABSTRACT

A diffusing capacity predicting apparatus according to the present disclosure includes a memory including one or more instructions and a processor which executes the one or more instructions stored in the memory. In the memory, first information about a spirometry result of a user, second information which is clinical information, a first machine learning model, and a second machine learning model are recorded. The processor inputs the first information to the first machine learning model to extract a feature related to a lung disease and inputs the extracted feature and the second information to the second machine learning model to predict a diffusing capacity value of the user. Accordingly, the diffusing capacity may be more accurately predicted using the spirometer result and the artificial intelligence model, without using the diffusing capacity test method.

### CROSS-REFERENCE TO RELATED APPLICATIONS

This application claims the priority of Korean Patent Application No. 10-2023-0194902 filed on Dec. 28, 2023 and Korean Patent Application No. 10-2024-0201354 filed on Dec. 30, 2024, in the Korean Intellectual Property Office, the disclosures of which are incorporated herein by reference in their entirety.

### BACKGROUND

### Field

The present disclosure relates to a diffusing capacity test, among pulmonary function tests, and more particularly, to a technology for predicting a diffusing capacity of the lung for CO (DLCO) using a flow-volume curve image.

### Description of the Related Art

The pulmonary function tests are tests for evaluating a respiratory capacity, ventilation, and a gas-exchange capacity of the lung and are used to diagnose lung disorders or evaluate a treatment progress.

The respiration is performed by inhaling oxygen and exhaling carbon dioxide so that the function of the lung is tested by evaluating whether gas exchange occurs well in the lung.

The pulmonary function tests include a spirometry, a diffusing capacity test, and a lung volume test.

### SUMMARY

The spirometry is performed by measuring a volume and a flow rate of air during inhalation and exhalation using a spirometer. The spirometry is a simple and highly reproducible test, but it has a disadvantage that the flow-volume curve which is the result has a limited clinical usability.

The diffusing capacity test is a method for evaluating how efficiently the lungs exchange gas and tests the diffusing capacity of carbon monoxide (CO) gas in the lungs by inhaling a small amount of carbon monoxide gas, holding the breath for a predetermined period of time, and then blowing it out.

However, during the diffusing capacity test, patients need to inhale as much as possible, hold the breath for a long time, and then exhale so that even health people may have difficulty with the test, which may cause inconsistent test results. Moreover, patients with pulmonary function insufficiency, such as patients with idiopathic pulmonary fibrosis, may have difficulty to take the tests properly, and the results may be significantly less accurate.

Inventors of the present disclosure have completed the present disclosure which may more accurately predict the diffusing capacity of the lung for carbon monoxide (DLCO) by analyzing the flow-volume curve image using artificial intelligence, without using the diffusing capacity test.

Aspects of the present disclosure provide predicting the diffusing capacity of the lung for carbon monoxide by analyzing a flow-volume curve image which is obtained using the spirometry, using the artificial intelligence.

However, the objects to be achieved by the present disclosure are not limited to the disclosed objects, and other objects which are not mentioned above will be apparently understood to a person having ordinary skill in the art from the following description.

According to aspects of the present disclosure, a diffusing capacity predicting apparatus using a flow-volume curve according to an example embodiment includes a memory including one or more instructions and a processor which executes the one or more instructions stored in the memory. In the memory, first information about a spirometry result of a user, second information which is clinical information, a first machine learning model, and a second machine learning model are recorded. The processor inputs the first information to the first machine learning model to extract a feature related to a lung disease and inputs the extracted feature and the second information to the second machine learning model to predict a diffusing capacity value of the user.

In the example embodiment of the present disclosure, the first information may include flow-volume curve data.

In the example embodiment of the present disclosure, the flow-volume curve data may be 2D image data of the flow-volume curve.

In the example embodiment of the present disclosure, the processor pre-processes the spirometry result to acquire a flow-volume curve image.

In the example embodiment of the present disclosure, the diffusing capacity value is a diffusing capacity of the lung for carbon monoxide (DLCO) value.

In the example embodiment of the present disclosure, the first machine learning model is trained to extract feature information about a lung disease on the basis of first data about a spirometry result including a flow-volume curve about a plurality of users which is prepared in advance and second data including clinical information for the plurality of same users as training data and the clinical information may include information about a lung disease of each user.

In the example embodiment of the present disclosure, the first machine learning model may include an EfficientNet model structure.

In the example embodiment of the present disclosure, the second machine learning model may be trained to predict the diffusing capacity value on the basis of third data including feature information about the plurality of users and fourth data about the diffusing capacity value for the plurality of same users which is prepared in advance as training data.

In the example embodiment of the present disclosure, the second machine learning model may include a structure of Extreme gradient boosting (XGBoost)) or random forest (RF) model.

According to aspects of the present disclosure, a diffusing capacity predicting method using a flow-volume curve according to an example embodiment may include the steps of: predicting a diffusing capacity using one or more instructions stored in a memory, a first machine learning model, and a second machine learning model by a processor and receiving first information about a spirometry result of a user and second information which is clinical information, extracting a feature related to a lung disease by inputting the first information to the first machine learning model, and predicting a diffusing capacity value of the user by inputting the extracted feature and the second information to the second machine learning model.

According to the present disclosure, a spirometry result which is more simple and reproducible than the diffusing capacity test is analyzed using artificial intelligence to more accurately predict a diffusing capacity of the lung for carbon monoxide.

Further, there is an advantage in that the diffusing capacity of the lung for carbon monoxide is predicted only by the spirometry to reduce the discomfort of the patient due to the diffusing capacity test.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic structural diagram of a diffusing capacity predicting apparatus using a flow-volume curve image according to any example embodiment of the present disclosure;

FIG. 2 is a detailed structural diagram of a diffusing capacity predicting apparatus using a flow-volume curve according to any example embodiment of the present disclosure;

FIGS. 3A to 3C sequentially illustrate a pre-processing process of a diffusing capacity predicting apparatus using a flow-volume curve according to any example embodiment of the present disclosure;

FIGS. 4A and 4B illustrate examples of flow-volume curves of a healthy person and a patient with the IPF disease, respectively;

FIG. 5 illustrates a result of predicting a diffusing capacity by a diffusing capacity predicting apparatus using a flow-volume curve according to any example embodiment of the present disclosure; and

FIGS. 6 and 7 are schematic flowcharts of a diffusing capacity predicting method using a flow-volume curve according to another example embodiment of the present disclosure.

### DETAILED DESCRIPTION OF EMBODIMENTS

The above aspects, means, and effects of the present disclosure will be more obvious from the detailed description with reference to the accompanying drawings, and the technical spirit of the present disclosure may be easily carried out by a person having ordinary skill in the art. Further, in description of the present disclosure, a detailed explanation of known technology related to the present disclosure may be omitted so as to avoid unnecessarily obscuring the subject matter of the present disclosure.

The terms used in the present specification are for explaining the embodiments rather than limiting the present disclosure. Unless particularly stated otherwise in the present specification, a singular form also includes a plural form. In the present specification, the terms, such as “include”, “is equipped with”, “is provided with”, or “have” do not exclude the presence or addition of one or more components other than those mentioned.

In the present specification, the terms, such as “or” or “at least one”, refer to one of words listed together or a combination of two or more. For example, “A or B” or “at least one of A and B” may include only one of A or B or include both A and B.

In the present disclosure, in the description followed by “for example”, presented information, such as the cited characteristics, variables, or values, may not exactly match and various example embodiments of the present disclosure should not be limited by effects, such as tolerances, measurement errors, or limits of measurement accuracy, and variations including other commonly known factors.

When it is described that a component is “coupled” or “connected” to another component, it should be understood that, the component may be directly coupled or directly connected to the other component or coupled or connected to the other component with a third component therebetween. In contrast, when it is described that a component is directly coupled or directly connected to another component, it should be understood that no component is present between the component and the other component.

When it is described that a component is placed “above” or “in contact with” another component, it should be understood that the component may directly meet on the other component or connected to the other component, but there may be a third component therebetween. In contrast, when it is described that a component is placed “directly on” or “in direct contact with” another component, it should be understood that no component is present between the component and the other component. Another expression which describes a relationship between components, such as “between ˜” and “directly between ˜” may be interpreted in the similar way.

Terms, such as “first” or “second” may be used to describe various components but the components are not limited by the above terms. Further, the above-mentioned term should not be interpreted to limit the order of the components, but may be used to distinguish one component from another component. For example, a “first component” may be referred to as a “second component”, and similarly, a “second component” may be referred to as a “first component”.

Unless otherwise defined, all terms used in the present specification may be used as the meaning which may be commonly understood by the person with ordinary skill in the art, to which the present disclosure belongs. It will be further understood that terms defined in commonly used dictionaries should not be interpreted in an idealized or excessive sense unless expressly and specifically defined.

Hereinafter, embodiments according to the present disclosure will be described in detail with reference to the accompanying drawings.

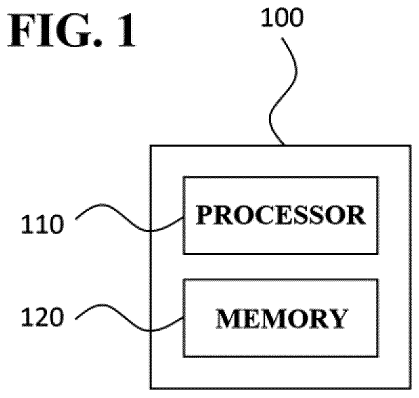

FIG. 1 is a schematic structural diagram of a diffusing capacity predicting apparatus using a flow-volume curve according to any example embodiment of the present disclosure.

A diffusing capacity predicting apparatus 100 using a flow-volume curve according to the present disclosure includes one or more processors 110 and a memory 120.

In the memory 120, instructions, data structures, and program codes which are readable to the processor 110 may be stored. In the example embodiments, at least operations which are performed by the processor 110 may be implemented by executing instructions or codes of the program stored in the memory 120.

The memory 120 may include flash memory type, hard disk type, multimedia card micro type, and card type memories (for example, SD or XD memory and the like) and also include a non-volatile memory including at least one of a read only memory (ROM), an electrically erasable programmable read only memory (EEPROM), a programmable read only memory (PROM), a magnetic memory, a magnetic disk, and an optical disk, and a volatile memory, such as a random access memory (RAM), a static random access memory (SRAM).

The memory 120 may store one or more instructions or programs which may be used by the diffusing capacity predicting apparatus 100 using a flow-volume curve to predict a diffusing capacity value using a flow-volume curve image.

The processor 110 controls overall operations of the diffusing capacity predicting apparatus 100 using a flow-volume curve. For example, the processor 110 executes one or more instructions stored in the memory 120 to allow the diffusing capacity predicting apparatus 100 using a flow-volume curve to train an artificial intelligence model using an input flow-volume curve and clinical data and control an overall operation for predicting the diffusing capacity using the artificial intelligence model.

The processor 110, for example, may be configured by at least one of a central processing unit, a microprocessor, a graphic processing unit, application specific integrated circuits (ASICs), digital signal processors (DSPs), digital signal processing devices (DSPDs), programmable logic devices (PLDs), field programmable gate arrays (FPGAs), application processor, neural processing unit, or an artificial intelligence dedicated processor designed with a hardware structure specified to process the artificial intelligence model, but is not limited thereto.

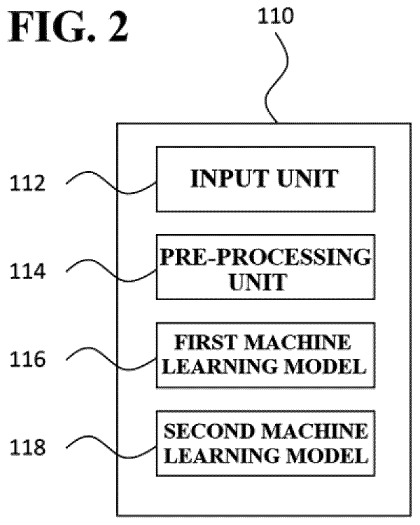

FIG. 2 is a detailed structural diagram of a diffusing capacity predicting apparatus using a flow-volume curve according to any example embodiment of the present disclosure.

The processor 110 may include an input unit 112, a pre-processing unit 114, a first machine learning model 116, and a second machine learning model 118.

The input unit 112 may receive flow-volume curve data which is a result of spirometry of a subject and clinical data.

The flow-volume curve data may have a 2D image format.

The clinical data includes information such as age, gender, height, and weight of the subject, whether to have a lung disease, and a type of the lung disease. Further, the clinical data includes values, such as forced vital capacity (FVC) or forced expiratory volume in the first 1 second (FEV1), which are value results of the spirometry.

The pre-processing unit 114 pre-processes the input flow-volume curve data.

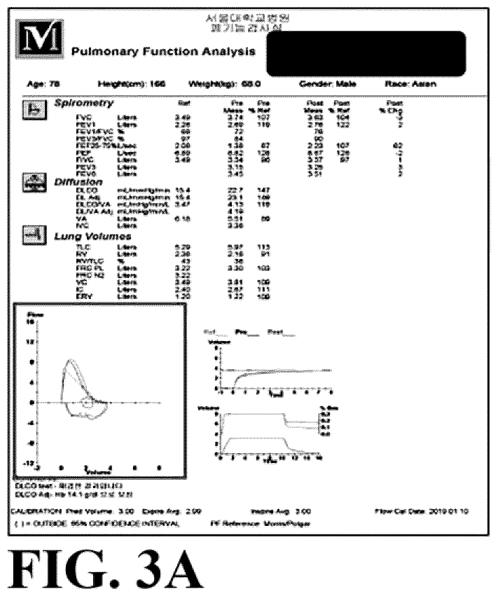

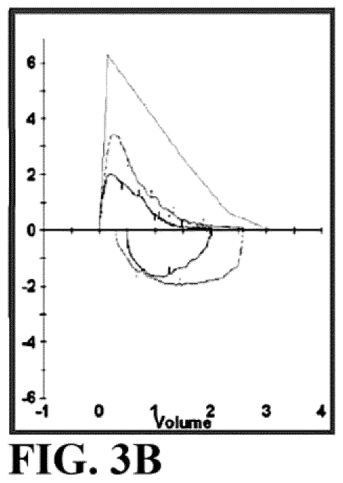

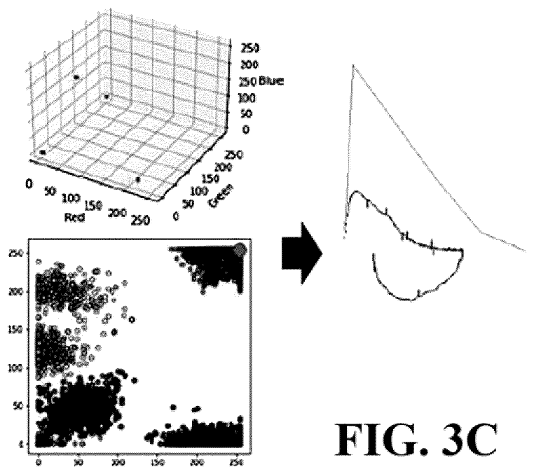

FIGS. 3A to 3C sequentially illustrate a pre-processing process of a diffusing capacity predicting apparatus using a flow-volume curve according to any example embodiment of the present disclosure.

FIG. 3A illustrates an example of a result sheet of the spirometry.

The input result sheet of the spirometry includes various data in addition to the flow-volume curve so that the pre-processing unit 114 may extract only a flow-volume curve area therefrom.

FIG. 3B illustrates an example of a result obtained by extracting only the flow-volume curve area from the result sheet of the spirometry.

Finally, the pre-processing unit 114 generates a flow-volume curve image to be used as an input of the first machine learning model 116 by extracting only a required part of the flow-volume curve and removing a noise.

FIG. 3C illustrates an example of a flow-volume curve from which a noise is finally removed.

The first machine learning model 116 is used to extract a feature of the flow-volume curve image.

To this end, the first machine learning model 116 may be trained in advance by the relationship of a flow-volume curve of various patients or healthy people and a lung disease.

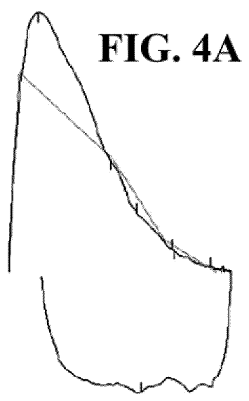

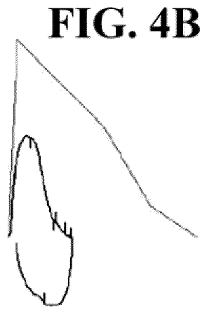

FIGS. 4A and 4B illustrate examples of flow-volume curves of a healthy person and a patient with the IPF disease, respectively.

Idiopathic pulmonary fibrosis (IPF) is a chronic progressive lung disease in which alveolar walls are hardened and a lung function is deteriorated. The IPF is a disease in which a structure of the lung tissue is seriously changed due to chronic inflammatory cells infiltrating the alveolar walls and the lung function is deteriorates to lead the death.

FIG. 4A is a flow-volume curve of a healthy person which is pre-processed and FIG. 4B is a flow-volume curve of a patient with IPF which is pre-processed.

The first machine learning model 116 may be trained in advance by various flow-volume curves and a feature including whether the flow-volume curve image is normal or abnormal may be extracted by the trained first machine learning model 116.

The first machine learning model 116 for extracting a feature may be an EfficientNet model, but is not limited thereto.

The second machine learning model 118 predicts a diffusing capacity value by a feature of the flow-volume curve image extracted using the first machine learning model 116 and clinical data of the subject.

The diffusing capacity value is a value for measuring a lung's ability to transfer gases to blood, using a gas which is more soluble in the blood than in the lung. The gas used to measure the diffusing capacity may be carbon monoxide (CO) or oxygen (O₂), but is not limited thereto.

In order to predict the diffusing capacity value, the second machine learning model 118 is trained in advance with a feature of the flow-volume curve image and clinical data of the subject and diffusing capacity value data. Data for training is classified into training data and verification data to be used to train and verify the second machine learning model 118.

The second machine learning model 118 may be an extreme gradient boosting (XGBoost) or a random forest (RF) model, but is not limited thereto.

The trained second machine learning model 118 predicts the diffusing capacity value using a regression model which is a network trained in advance with a feature extracted from the flow-volume curve image and the clinical data of the subject as inputs.

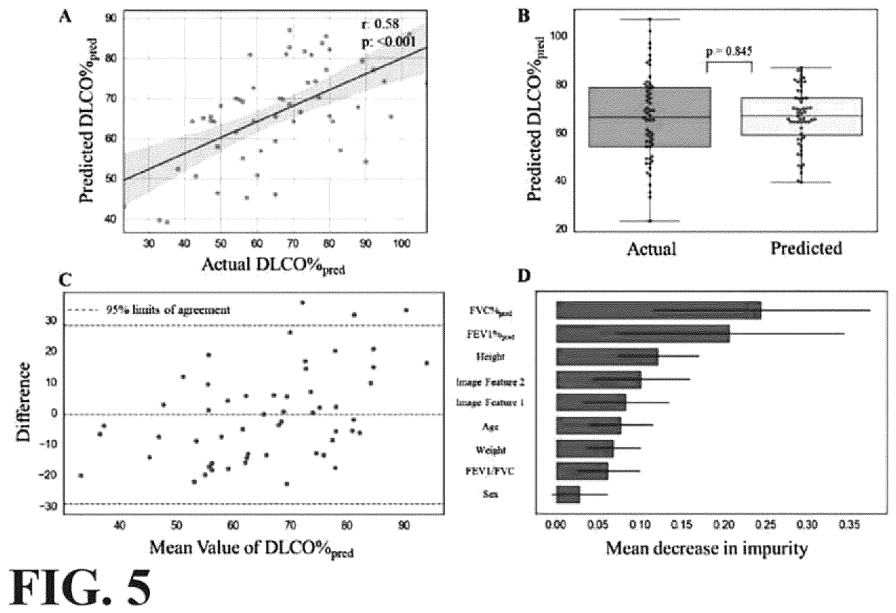

FIG. 5 illustrates a result of predicting a diffusing capacity by a diffusing capacity predicting apparatus using a flow-volume curve according to any example embodiment of the present disclosure.

FIG. 5 illustrates a result of predicting a diffusing capacity of the lung for carbon monoxide (DLCO) value, among the diffusing capacity values, by combining the flow-volume curve image and the clinical data of the subject.

It is confirmed that a value (Predicted) obtained by predicting the DLCO by combining the flow-volume curve image and the clinical data of the subject according to the present disclosure is more accurate than a DLCO value (actual) predicted by a normal predicting method of the related art.

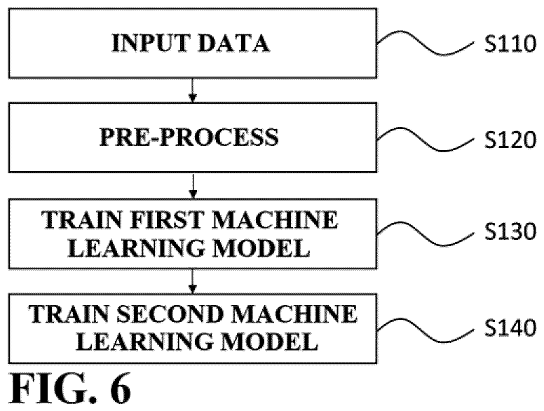

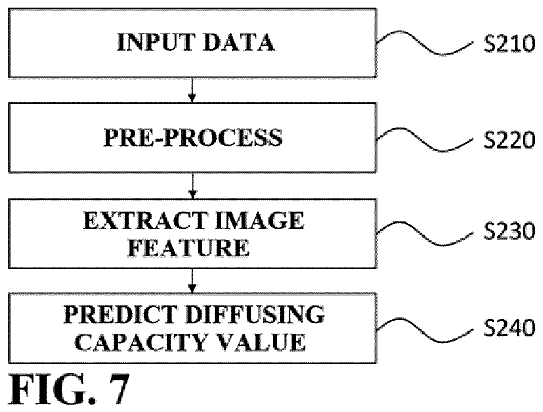

FIGS. 6 and 7 are schematic flowcharts of a diffusing capacity predicting method using a flow-volume curve according to an example embodiment of the present disclosure.

A diffusing capacity predicting method using a flow-volume curve according to the present disclosure is performed by a diffusing capacity predicting apparatus using a flow-volume curve, including one or more processors and a memory.

FIG. 6 illustrates a schematic process of training a first machine learning model to predict a diffusing capacity using a flow-volume curve first.

First, spirometry data including a flow-volume curve of a subject and clinical data of the subject are input in step S110.

The spirometry data includes various test results including a flow-volume curve so that a pre-processing process is performed to separate only a flow-volume curve and remove a noise in step S120.

The first machine learning model is trained by the flow-volume curve image which is pre-processed in step S130.

The first machine learning model is trained to extract a feature from the flow-volume curve image.

Finally, a feature extracted by the first machine learning model and input clinical data of the subject are combined to train the second machine learning model for predicting the diffusing capacity value in step S140.

FIG. 7 illustrates a schematic process of predicting a diffusing capacity value using machine learning models which is trained as described above.

Data of the subject is input in the same way as the first and second machine learning model training processes in step S210 and a flow-volume curve image is obtained through the pre-processing process in step S220.

Next, a feature of a flow-volume curve image is extracted by the first machine learning model which is trained in advance in step S230.

As described above, the feature of the flow-volume curve image may be whether there is IPF (Idiopathic pulmonary fibrosis), but is not limited thereto.

Finally, the extracted feature of the flow-volume curve image and the clinical data of the subject are input to the second machine learning model to predict the diffusing capacity value in step S240.

The diffusing capacity value may be a DLCO value, but is not limited thereto.

As described above, the apparatus and method for predicting a diffusing capacity using a flow-volume curve image according to the present disclosure have advantages that the diffusing capacity value is more easily and accurately predicted using the flow-volume curve and the artificial intelligence so that patients who have difficult with diffusing capacity tests may take the test without any discomfort and predict the diffusing capacity.

Although specific example embodiment has been described in the detailed description of the present disclosure, it should be understood that various modification may be allowed without departing from the scope of the present disclosure. Accordingly, the scope of the present disclosure is not limited to the described embodiment and should be determined by the claims set forth below and their equivalents.

What is claimed is:

1. A diffusing capacity predicting apparatus using a flow-volume curve, comprising:
a memory including one or more instructions; and
a processor which executes the one or more instructions stored in the memory,
wherein the memory is configured to record first information of a spirometry result of a user, second information of clinical information, a first machine learning model, and a second machine learning model.
the processor is configured to:
extract a feature related to a lung disease by inputting the first information to the first machine learning model, and
predict the diffusing capacity of the user by inputting the extracted feature and the second information to the second machine learning model.

2. The apparatus according to claim 1, wherein the first information includes flow-volume curve data.

3. The apparatus according to claim 2, wherein the flow-volume curve data is 2D image data of the flow-volume curve.

4. The apparatus according to claim 2, wherein the processor is further configured to pre-process the spirometry result to acquire a flow-volume curve image.

5. The apparatus according to claim 1, wherein the diffusing capacity is a diffusing capacity of the lung for carbon monoxide (DLCO).

6. The apparatus according to claim 1, wherein the first machine learning model is configured to be trained to extract feature information about the lung disease on the basis of first data on the spirometry result including the flow-volume curve of a plurality of users and second data including the clinical information about the same users, and
the clinical information includes information about the lung disease of each user.

7. The apparatus according to claim 6, wherein the first machine learning model includes an EfficientNet model structure.

8. The apparatus according to claim 6, wherein the second machine learning model is configured to be trained to predict the diffusing capacity on the basis of third data including feature information about the plurality of users and fourth data on the diffusing capacity of the same users.

9. The apparatus according to claim 8, wherein the second machine learning model includes a structure of extreme gradient boosting (XGBoost) or random forest (RF) model.

10. A method for predicting a diffusing capacity using one or more instructions stored in a memory, a first machine learning model, and a second machine learning model by a processor, comprising:
receiving first information of a spirometry result of a user and second information of clinical information;
extracting a feature related to a lung disease by inputting the first information to the first machine learning model; and
predicting a diffusing capacity of the user by inputting the extracted feature and the second information to the second machine learning model.
